(19) United States
(12) Patent Application Publication
(10) Pub. No.: US 2025/0353607 A1
(43) Pub. Date: Nov. 20, 2025

(54) DEVICE FOR CLEANING FUEL AND USE THEREOF

(71) Applicants: LUFTHANSA TECHNIK AG, Hamburg (DE); DEUTSCHE LUFTHANSA AG, Cologne (DE)

(72) Inventors: Manfred Runge, Wolmersdorf (DE); Christian Siry, Hamburg (DE); Andreas Schmidt, Egelsbach (DE)

(21) Appl. No.: 19/104,235

(22) PCT Filed: Aug. 16, 2023
(86) PCT No.: PCT/EP2023/072500

§ 371 Date: Feb. 17, 2025

(30) Foreign Application Priority Data
Aug. 22, 2022 (DE) 10 2022 121 171.1

(51) Int. Cl. B64D 37/18; B64D 37/20; B64F 1/28; B67D 7/04; B67D 7/62; B67D 7/76

(52) U.S. Cl. CPC B64D 37/18; B64D 37/20; B64F 1/28; B67D 7/04; B67D 7/62; B67D 7/766

(57) ABSTRACT

A device for cleaning fuel located in a tank of an aircraft, having a prescribed flow direction for the fuel and units fluidically connected to one another for transfer of fuel. The device includes in the flow direction an extractor configured to extract fuel from the tank of the aircraft, a filter configured to filter the extracted fuel, and a recirculator. The recirculator is configured to return the filtered fuel to the tank of the aircraft. The recirculator includes a hose configured to provide selective fluid connection of the device to the tank of the aircraft. A pump is provided for moving the fuel, at least through the hose of the recirculator.

### CROSS REFERENCE TO RELATED APPLICATIONS

This application is a U.S. National Phase application under 35 U.S.C. § 371 of International Application No. PCT/EP2023/072500, filed on Aug. 16, 2023, and claims benefit to German Patent Application No. DE 10 2022 121 171.1, filed on Aug. 22, 2022. The International Application was published in German on Feb. 29, 2024 as WO 2024/041934 A1 under PCT Article 21 (2).

### FIELD

The invention relates to a device for cleaning fuel located in a tank of an aircraft and to the methods of use thereof.

### BACKGROUND

Contaminants can occur in fuel stored in aircraft tanks. In addition to contaminants introduced into the tank through openings, e.g. during refueling or maintenance, such as, for example, metal shavings, sealant residues, and other production or maintenance debris, bacteria, mold, and fungi can form in the tank, particularly when aircraft are idle for prolonged periods, said contaminants—at least insofar as they do not adhere firmly to the interior surfaces of the tank—also leading to contamination of the fuel. At the latest, when microbial contamination of the interior wall of the tank is also treated with toxic biocides known from the prior art, the fuel, however, becomes contaminated with biomass—in the form of dead microbes. Possible excretions from any remaining living microbes can also lead to contamination of the fuel.

In order to prevent contaminants in the fuel from reaching the propulsion system of the aircraft, fuel filters are known in the art, with which solids above a predetermined size can be filtered out of the fuel during operation. A disadvantage of this prior art is that, particularly with heavily contaminated fuel, the fuel filter can clog up during operation, posing a safety risk.

If there is substantial contamination of the tank or the fuel contained therein, particularly due to microbes, it is known in the art—particularly in order to mitigate the risk of filter clogging—for an affected tank to be cleaned through a tank opening and “tank entry and inspection”. Tank inspections of this kind are complex, which is why they can only be performed by specially qualified and trained personnel, and they typically take several days, partly due to preceding steps such as defueling and ventilation steps, during which a hangar space is usually occupied continuously.

### SUMMARY

In an embodiment, the present disclosure provides a device for cleaning fuel located in a tank of an aircraft, having a prescribed flow direction for the fuel and units fluidically connected to one another for transfer of fuel. The device comprises in the flow direction an extractor configured to extract fuel from the tank of the aircraft, a filter configured to filter the extracted fuel, and a recirculator. The recirculator is configured to return the filtered fuel to the tank of the aircraft. The recirculator comprises a hose configured to provide selective fluid connection of the device to the tank of the aircraft. A pump is provided for moving the fuel, at least through the hose of the recirculator.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first exemplary embodiment of a device according to the present disclosure;

FIG. 2 shows a schematic detailed representation of the device shown in FIG. 1; and

FIG. 3 shows a schematic detailed representation of a second exemplary embodiment of a device according to the present disclosure.

### DETAILED DESCRIPTION

In an embodiment, the present disclosure provides a device for cleaning fuel located in a tank of an aircraft and the methods of use thereof, in which the disadvantages known from the prior art no longer arise, or only to a lesser extent.

The present disclosure therefore relates to a device for cleaning fuel located in a tank of an aircraft, having a flow direction for the fuel and units fluidically connected to one another for the transfer of fuel, comprising in the flow direction:
an extraction unit for extracting fuel from a tank of an aircraft;
a filter unit for filtering the extracted fuel; and
a recirculation unit for returning the filtered fuel to the tank of the aircraft, comprising a hose for selective fluid connection of the device to the aircraft tank,
   wherein a pump is provided for moving the fuel, at least through the hose of the recirculation unit.

Furthermore, the present disclosure relates to the use of the device according to embodiments of the present disclosure, in which the extraction unit (10) and the recirculation unit (70) are connected to the same aircraft tank.

To begin with, a few terms used in connection with the present disclosure will be explained.

A “prescribed flow direction” through a device refers to the direction along which a liquid—in this case fuel—flows primarily through the individual units of the device during correct use. The flow direction in this case does not provide information about the actual flow direction of the liquid within the device, but serves solely to identify the order in which the units are crossed. It is also not excluded that the liquid can remain stationary in certain areas and/or for certain periods or even flow against the specified flow direction.

Two units are “fluidically connected” when the units are connected to one another in such a manner that a liquid can flow from one unit to the other, particularly in the prescribed flow direction.

The device according to the present disclosure creates the opportunity for efficient cleaning of fuel in the tank of an aircraft that is stationary on the ground with minimal effort using a circulation process to filter out solid particles that may be present in the fuel, thereby reducing the load on the fuel filter of the aircraft during operation: If at least part, preferably the majority, of the solids in the fuel have already been removed by the device according to the present disclosure, the fuel filter of the aircraft will have fewer particles to filter during operation. This increases the reliability of the fuel filter and, consequently, the fuel supply of the aircraft during operation. Furthermore, the early removal of fuel contaminants helps to prevent the contamination of the interior surfaces of the tank, thereby reducing the risk of damage to the aircraft, such as corrosion caused by, or accelerated by, contamination.

In this case, the device according to the present disclosure comprises at least the following components-arranged in the order in which the units are crossed in the prescribed flow direction-at least one extraction unit, a filter unit, and a recirculation unit, wherein the units are each fluidically connected to one another. Through the extraction unit, the fuel is drawn from an aircraft tank into the device according to the present disclosure and then passes through the filter unit, in which the fuel is filtered by removing solid particles above a specified size. The filtered fuel is subsequently returned to the aircraft tank from which it was originally drawn via the recirculation unit and a hose. The device also comprises a pump in this case that allows the filtered fuel to be pumped back into the aircraft tank.

The pump in this case can be part of the recirculation unit. The flow through the units located upstream of the recirculation unit in the flow direction, such as the filter unit, can be facilitated by gravity in this case, additional pump devices, or the suction effect of the pump in the recirculation unit.

Alternatively, the pump can be positioned at a different point within the device, for example upstream of the filter unit in the flow direction. In an arrangement of this kind, it must simply be ensured that the pump also transports the fuel through the hose of the recirculation unit.

The cleaning of the fuel can be carried out continuously in an immediate circulation process, with the appropriate configuration of the device, meaning that fuel extracted via the extraction unit is immediately returned to the tank via the recirculation unit after passing through the filter unit or the device. However, an intermediate storage unit can be provided between the filter unit and the recirculation unit, allowing the filtered fuel to be temporarily stored before being returned to the tank. This kind of intermediate storage enables the recirculation of the fuel to be delayed relative to its extraction, thereby reducing the mixing of unextracted, unfiltered fuel with already filtered, returned fuel in the aircraft tank. With a sufficiently large intermediate storage unit, recirculation can even be postponed until all fuel has been extracted from the aircraft tank, thereby completely eliminating the mixing referred to above.

The intermediate storage unit can directly comprise an intermediate storage element, for example in the form of a tank. However, it is preferred that the intermediate storage unit comprises a connection module for connecting an external intermediate storage tank, such as the tank of a fuel truck, for example. By not incorporating the storage tank directly into the intermediate storage unit, the unit, as well as the entire device, can be made smaller and more manageable. An external intermediate storage tank would only need to be connected to the connection module of the intermediate storage unit when an intermediate storage tank is specifically required for a particular cleaning operation. It is also provided for the intermediate storage module to have both its own intermediate storage tank and a connection module. In this configuration, an additional external tank can be attached via the connection module to expand the storage capacity as needed. The connection module can comprise at least one connection point for attaching an external intermediate storage tank thereto, and it can also comprise a pump for moving fuel into and/or out of the intermediate storage tank.

The extraction unit is preferably connected to the aircraft tank independently of, and separately from, the recirculation unit, as will also be explained in greater detail below. However, the hose of the recirculation unit can also be used to extract the fuel from the tank, particularly, for example, in the case of aircraft tanks with only one, or at least only an easily accessible tank opening. In this case, a switching module can be provided, allowing the hose of the recirculation unit to be selectively fluidically connected to the extraction unit as well as the recirculation unit. The hose can therefore be used, as needed, for fuel extraction and recirculation. Since extraction and recirculation cannot occur simultaneously in this case, an intermediate storage unit will generally have to be provided with this variant.

Alternatively, instead of sharing the hose of the recirculation unit, the extraction unit can comprise at least one hose fluidically connected to it for coupling with a fuel drain opening and/or another opening of the aircraft tank. A “fuel drain opening” refers to an opening on the fuel tank located at or near the lowest point(s) of the fuel tank when the aircraft is parked on a flat surface, allowing the fuel to flow out by gravity when the fuel drain opening is open. To connect the hose of the extraction unit, it can be sufficient to equip its free end with a funnel to collect fuel draining from the fuel drain opening. However, in order to reduce the risk of fire, it is preferable to equip the free end of the extraction unit hose with a hose coupling that can create a sealed connection with an opening in the fuel tank.

As previously explained, the fuel can be extracted from an aircraft fuel tank solely by gravity. However, the extraction unit can also be designed for suction-based fuel extraction using at least one hose fluidically connected to the extraction unit. A suction mechanism of this kind can support gravity-based fuel extraction where it is feasible or also allow fuel to be extracted through tank openings where gravity-based extraction is not possible. In this case, the hose can be equipped at its free end with a hose coupling for secure connection to an aircraft tank opening or designed as a suction hose for open aircraft tanks. By using suction, the flow rate of fuel through the at least one hose can be precisely controlled. Preferred flow rates in this case range from 0.3 m/s to 7 m/s, preferably 2 m/s to 3 m/s.

The suction can be achieved solely through the suction effect of the pump provided to move fuel through the hose of the recirculation unit. Alternatively, the extraction unit can comprise a separate suction pump.

It is preferable for a water separation unit to be fluidically connected either upstream or downstream of the filter unit in the flow direction, in order for water to be separated from the extracted fuel. The water separation unit can remove any water present in the fuel, which might otherwise cause corrosion to metal components that come into contact with the fuel. The separation of water and fuel can be achieved using a known technique, such as vortexing. In particular, it is preferred in this case for the water separation unit to be externally powered, so that the vortexing necessary for water separation does not depend on the flow rate of the fuel through the water separation unit. In addition, the water separation unit can be sensor-controlled, enabling its operating parameters to be adjusted based on the actual water content in the fuel.

If it can be assumed that the fuel and any water present in the tank are already separated into distinct phases within the tank and can also be extracted separately from one another, the water separation unit can be configured as a sensor-controlled three-way valve with one inlet and two switchable outlets. When a suitable sensor in the water separation unit detects water entering the valve inlet, the valve can be switched to the outlet connected, for example, to a collection container; if the sensor detects fuel at the valve inlet, the valve can be switched to the outlet that directs the fuel to the unit arranged downstream of the water separation unit in the flow direction, such as the filter unit.

The filter unit can comprise one or multiple filters connected in series. The filter or filters can preferably have a fineness from 0.2 μm to 15 μm, wherein the fineness of multiple filters arranged in series preferably decreases in the prescribed flow direction, so that filtration progresses from coarse to fine. In order to filter out microbiological components from the fuel, a filter fineness of 0.2 μm is desirable in principle. However, depending on the tank volumes and contamination level, a filter with this kind of fineness can quickly become clogged, making such a filter suitable for only a few applications.

The filters can, in principle, be made from any materials suitable for use with aviation fuels. The filters can preferably be made of metal, in order to ensure a long service life.

It is preferable for the filter unit to have one or multiple sampling point(s). These sampling points allow for the extraction of samples of the fuel flowing through the filter unit, so that the fuel can undergo laboratory analysis and the functionality of the filter unit, or the entire device, can thereby be evaluated.

The filter unit can comprise a differential pressure measuring device to measure the pressure differential before and after the filter unit or individual filters therein. This allows for the detection of blockages in the filter unit or one of the individual filters therein. By analyzing the increase in pressure differential relative to the volume of the filtered fuel, initial conclusions can be drawn as to the degree of contamination of the fuel.

A UV disinfection unit can be arranged in a fluidically connected manner downstream of the filter unit in the flow direction. A UV disinfection unit of this kind can be used to kill or inactivate microbes in the fuel that were not removed by the filters due to their size.

The device can also comprise at least one conductivity measuring unit which measures the conductivity of the fuel flowing through the device. For example, a conductivity measurement performed downstream of the filter unit can verify whether the cleaned fuel meets the conductivity standards required for aviation fuel.

The device can also include an additive mixing unit for mixing additives into the fuel as it flows through the device. For example, additives to enhance the conductivity of the fuel, such as Static Dissipater Additives (SDA), can be added, for example based on the results of the conductivity measurement. In addition, biocides can be introduced to eliminate microbes still present in the fuel tank, and/or anti-icing agents (Fuel System Icing Inhibitors (FSII) or anti-icing agents) can be added to prevent fuel freezing.

The hose of the recirculation unit and/or a hose of the extraction unit can have a standard aircraft refueling coupling at its free end for this purpose, ensuring a simple and secure connection between the device and the aircraft tank. The aircraft refueling coupling can be a standard component and/or a coupling tailored to a specific aircraft model. Additionally, one or multiple adapters can be provided to allow the aircraft refueling coupling at the free end of the recirculation unit hose to connect with different aircraft models. Specifically, the free end of a hose from the recirculation unit and/or the extraction unit can preferably be provided with an aircraft refueling coupling conforming to the civil standard SAE AS5887.

The device can have a preferably central control unit, which is used to manage the controllable units or the controllable components thereof, wherein the control unit can also process measurement values or similar information related to the cleaning process or the functionality of the individual units. The control unit can be programmable, allowing it to perform fuel cleaning operations tailored to specific aircraft or their tanks.

The device can preferably be mounted entirely on a frame, so that it is easy to transport, including by air, for example. It can also be directly mounted on a vehicle.

Furthermore, the device can have its own power source, for example a battery or generator. Alternatively, the device can be designed for connection to an existing power network, such as a hangar power supply.

Reference is made to the preceding explanations to clarify the methods of use according to the present disclosure. In this case, units of the device used, if present, are generally operated as intended. The only exception to this is the intermediate storage unit, if available. Even if an intermediate storage unit is provided, which fundamentally allows the decoupling of the fuel return from the extraction thereof, a direct circulation cleaning process can still be realized with a corresponding device, by appropriately controlling the various units and their components to ensure that the intermediate storage unit remains substantially empty.

Independently of this, in the methods of use according to the present disclosure-depending on the desired cleaning process—the extraction and/or return of fuel from or into the tank of an aircraft can be carried out continuously or intermittently.

Embodiments of the present disclosure will now be described by way of example using an advantageous embodiment with reference to the accompanying drawings.

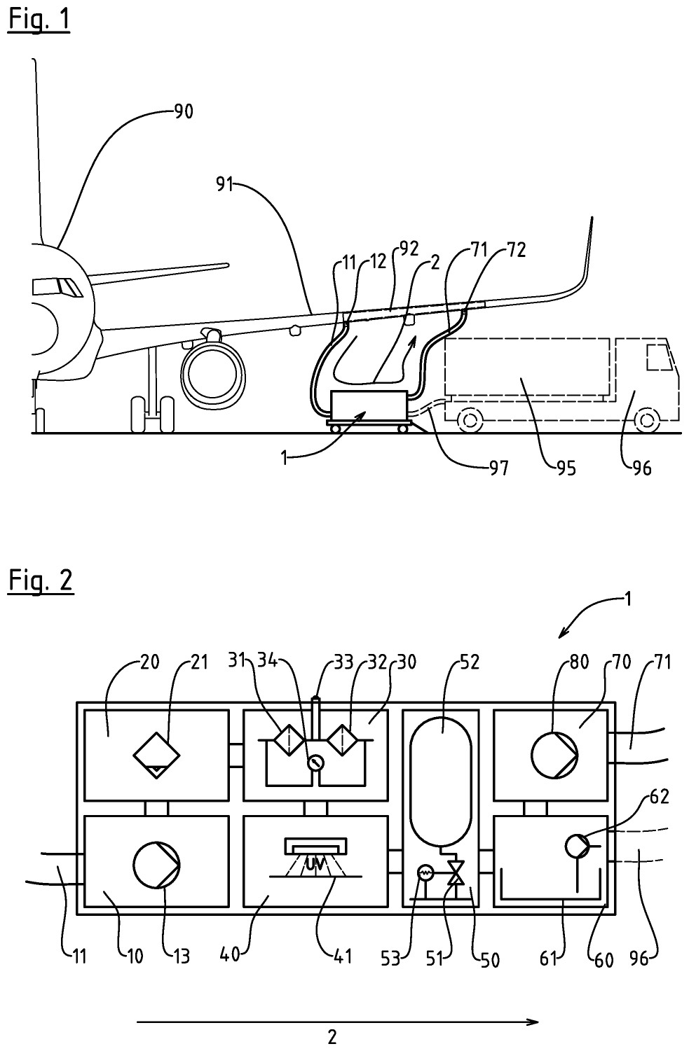

FIG. 1 shows schematically the use of a first exemplary embodiment of a device 1 according to the present disclosure which is represented in detail in FIG. 2, for cleaning fuel in the tank 92 of an aircraft 90. The tank 92 in this case is integrated in the wing 91 of the aircraft 90.

The device 1 is connected to a fuel drain opening of the tank 92 of the aircraft 90 via a hose 11 assigned to its extraction unit 10. For this purpose, the hose 11 has an adapter at its free end for connection to a tank bottom valve, which is located at the lowest point of the tank 92.

Furthermore, the device 1 is connected via a hose 71 assigned to the recirculation unit 70 to a tank opening that is typically used for refueling the aircraft 90. For this purpose, the hose 71 has an aircraft refueling coupling 72 at its free end, compliant with the SAE AS5887 standard.

A general flow direction 2 for the fuel is defined for the device 1, namely from the tank 92, through the hose 11 of the extraction unit 10, and back into the tank 92 via the hose 71 of the recirculation unit 70. Along this flow direction 2, the fuel passes through various units 10, 20, 30, 40, 50, 60, 70 within the device 1, which are fluidically connected in series and are explained in greater detail below with reference to FIG. 2.

The extraction unit 10 comprises a suction pump 13 which draws fuel through the hose 11. Regardless of whether the fuel could potentially flow through the hose 11 by gravity alone, the suction pump 13 ensures a constant fuel flow of approximately 1 m/s through the hose 11. In addition, the suction pump 13 ensures a constant fuel flow through the units downstream of the extraction unit 10.

Following the extraction unit 10, a water separation unit 20 is provided. The water separation unit 20 comprises a filter-water separator, preferably with an automatic drain 21. The water separation unit 20 can also comprise a sensor to detect the water content in the fuel flowing into or out of the filter water separator 21.

The fuel then flows into a filter unit 30. In the exemplary embodiment shown, the filter unit 30 comprises two filters 31, 32 connected in series, wherein the first filter 31, through which the fuel flows in the direction of flow 2, has a fineness of 5 μm, while the other filter 32 has a fineness of 1 μm. Between the two filters 31, 32, which are made of metal, a filter sampling point 33 is provided, which allows for the collection of partially filtered fuel—specifically, fuel filtered only by the first filter—for laboratory analysis. An analysis of this kind can determine, for example, whether the fineness ratio of the two filters 31, 32 has been appropriately selected to ensure sufficient filtration performance, on the one hand, while avoiding premature clogging of one of the filters 31, 32, on the other. If the first filter 31 is too fine compared with the second filter 32, which primarily determines the overall filtration outcome, the first filter 31 may possibly clog quickly; if the first filter 32 is too coarse, the second filter 32 may clog prematurely. Ideally, the fineness of the filters 31, 32 should be chosen so that they both clog at approximately the same rate.

The filter unit 30 also comprises a differential pressure measuring device 34 which measures the pressure differential before the first filter 31 and after the second filter 32. By monitoring the differential pressure, potential blockages in one of the two filters 31, 32 can be detected and a warning can be issued, for example, to prompt the cleaning or replacement of the filters 31, 32. As an alternative to a joint differential pressure measuring device 34, separate differential pressure measuring devices can also be provided for each filter 31, 32.

Following the filter unit 30, a UV disinfection unit 40 is provided, in which the fuel flowing through it is exposed to UV radiation, particularly UV-C radiation, along a UV disinfection path 41, to kill or inactivate vegetative microbes that may still be present in the fuel after filtration.

Following this, an additive mixing unit 50 is provided, which allows the addition of an additive—in this case, a conductivity-enhancing additive—from the storage tank 52 via a controllable valve 51 as needed. A conductivity measuring unit 53 is used to determine the amount of additive to be added. Based on the conductivity of the fuel measured after passing through the UV disinfection unit 40, the addition of the additive can be precisely controlled via the valve 51.

After passing through the additive mixing unit 50, the fuel enters an intermediate storage unit 60. The intermediate storage unit 60 comprises an intermediate storage tank 61 for temporarily storing a certain amount of fuel, allowing the extraction of fuel and its return to be decoupled in principle. In the event that the capacity of the intermediate storage tank 61 should be insufficient, the intermediate storage tank 60 also comprises a connection module 62 that allows an external tank 95, such as the tank 95 of a tanker truck 96, to be connected as needed—and therefore only indicated in dotted lines—to a hose 97 (cf. FIG. 1). The connection module 62 comprises a pumping device for transferring fuel from the intermediate storage tank 61 into the attached tank 95, and vice versa.

Fuel stored in the intermediate storage tank 61 of the intermediate storage unit 60, which is to be returned to the tank 92 of the aircraft 90, is pumped back via the recirculation unit 70 and the hose 71 thereof. For this purpose, the recirculation unit 70 comprises a suitable pump 80.

The functional operation of the device 1 follows directly from the above description: fuel extracted via the extraction unit 10 flows through the various cleaning units—water separation unit 20, filter unit 30, and UV disinfection unit 40, if needed, an additive is added to the fuel in the additive mixing unit 50 to enhance conductivity, and the cleaned fuel, now having the desired conductivity, is then temporarily stored in the intermediate storage unit 60—either in the intermediate storage tank 61 or in the external tank 95. From the intermediate storage tank 60, the fuel is then returned to the tank 92 of the aircraft 90 through the recirculation unit 70 or pumped back using the pump 80. In this case, depending on the nature of the cleaning required, an immediate return can be performed, meaning that the intermediate storage tank 61 is kept practically empty and the device 1 performs circulation cleaning; However, part, or even all, of the fuel from the tank 92 can be temporarily stored, thereby decoupling the fuel extraction and return processes in terms of timing.

A central control unit can be provided for managing the controllable components of the individual units 10-70, as described above, and the pump 80, which control unit can also be connected to the various sensors, etc., in order thereby to control the functions of the individual units 10-70 and the device 1 as a whole. The control unit can be programmable, allowing cleaning processes tailored to specific aircraft and their tanks 92 to be preprogrammed.

As depicted in FIG. 1, the device 1 can be arranged on a rolling cart. For its power supply, the device 1 has a connection to the electrical grid of a hangar.

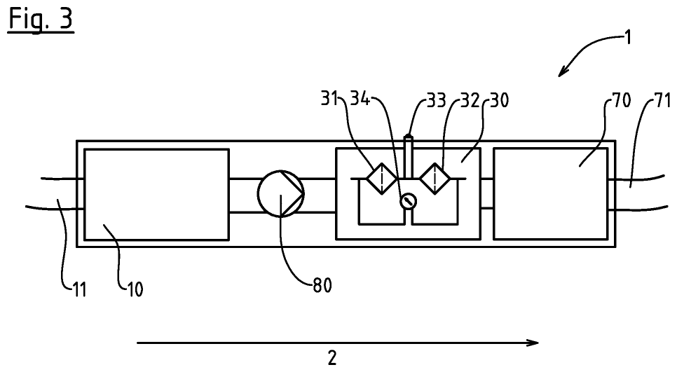

A second exemplary embodiment of the device 1 according to the present disclosure is depicted in FIG. 3. In this case, the device 1 can be used as described in FIG. 1, but includes only the minimum required units 10, 30, 70, compared with the device 1 shown in FIG. 2.

In the flow direction 2, the device 1 initially includes an extraction unit 10, followed by the pump 80, before fuel flowing through the device flows through the filter unit 30 and is then returned to the tank 92 of the aircraft 90, from which the fuel was originally extracted (cf. FIG. 1), via the recirculation unit 70 and the hose 71 thereof.

While the filter unit 30 in the device 1 shown in FIG. 3 is identical in construction to the filter unit 30 in the device 1 shown in FIG. 2, which is why reference is made to the explanations there, the extraction unit 10 and the recirculation unit 70 are designed as purely passive units: The extraction unit 10 does not comprise a suction pump 13 (cf. FIG. 2), the pump 80 is arranged outside of the recirculation unit 70.

To ensure the flow direction 2 of the device 1 and at least the recirculation of the fuel, the pump 80 is provided, which is arranged upstream of the filter unit 30 in the flow direction 2. The pump 80 in this case is designed to ensure that, even with a defined pressure drop across the filters 31, 32 of the filter unit 30, it delivers sufficient fuel so that the filtered fuel can be returned through the hose 71. Naturally, the pump 80 is also designed to resist clogging from the expected contaminants in the fuel.

In the exemplary embodiment shown in FIG. 3, the extraction of fuel can occur solely due to gravity. However, the pump 80 can also be designed to create a suction effect through the hose 11 of the extraction unit 10.

The device 1 shown in FIG. 3 can also include a central control unit, which ensures the proper operation of the device 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for cleaning fuel located in a tank of an aircraft, having a prescribed flow direction for the fuel and units fluidically connected to one another for transfer of fuel, the device comprising in the flow direction:
an extractor configured to extract fuel from the tank of the aircraft;
a filter configured to filter the extracted fuel; and
a recirculator configured to return the filtered fuel to the tank of the aircraft, the recirculator comprising a hose configured to provide selective fluid connection of the device to the tank of the aircraft,
wherein a pump is provided for moving the fuel, at least through the hose of the recirculator.

2. The device as claimed in claim 1, further comprising an intermediate storage between the filter and the recirculator, the intermediate storage is configured to allow fuel to be temporarily stored in an intermediate storage tank.

3. The device as claimed in claim 2, wherein the intermediate storage comprises a connection module configured to connect to an external intermediate storage tank.

4. The device as claimed in claim 2, further comprising a switching module configured to allow the hose of the recirculator to be selectively fluidically connected to the extractor.

5. The device as claimed in claim 1, wherein the extractor comprises at least one hose fluidically connected thereto and configured to fluidically couple with a fuel drain opening and/or a tank opening of the tank.

6. The device as claimed in claim 1, wherein the extractor comprises a suction pump configured to draw fuel through at least one hose fluidically connected to the extractor at flow rates of fuel through the at least one hose from 0.3 m/s to 7 m/s in a controlled manner.

7. The device as claimed in claim 1, wherein a water separator is fluidically connected upstream or downstream of the filter unit in the flow direction, the water separator being configured to separate water from the extracted fuel.

8. The device as claimed in claim 1, wherein the filter comprises one or multiple individual filters connected in series with a fineness from 0.2 μm to 15 μm and/or made of metal.

9. The device as claimed in claim 1, wherein the filter has one sampling point or multiple sampling points.

10. The device as claimed in claim 1, wherein the filter comprises a differential pressure measuring device.

11. The device as claimed in claim 1, wherein a an ultraviolet (UV) disinfector is arranged in a fluidically connected manner downstream of the filter in the flow direction.

12. The device as claimed in claim 1, further comprising at least one conductivity measuring unit configured to measure a conductivity of the fuel flowing through the device.

13. The device as claimed in claim 1, further comprising an additive mixer configured to mix additives into the fuel as the fuel flows through the device.

14. A method, comprising:
providing the device as claimed in claim 1; and
connecting the extractor and the recirculator to the same tank of the aircraft.

15. The method as claimed in claim 14, further comprising continuously or intermittently extracting and/or returning fuel from or into the same tank of the aircraft.

16. The device as claimed in claim 6, wherein the suction pump is configured to draw fuel at flow rates of from 2 m/s to 3 m/s in a controlled manner.

17. The device as claimed in claim 1, wherein the water separator is externally powered and/or sensor controlled.
